(19) United States
(12) Patent Application Publication
(10) Pub. No.: US 2024/0429980 A1
(43) Pub. Date: Dec. 26, 2024

(54) DIVERSITY MEASUREMENT

(71) Applicant: NOKIA TECHNOLOGIES OY, Espoo (FI)

(72) Inventors: Samantha CAPORAL DEL BARRIO, Aalborg (DK); Ahmad AWADA, Munich (DE); Halit Murat GÜRSU, Munich (DE)

(21) Appl. No.: 18/709,745

(22) PCT Filed: Dec. 6, 2022
(86) PCT No.: PCT/EP2022/084608

§ 371 Date: May 13, 2024

(30) Foreign Application Priority Data
Dec. 10, 2021 (FI) 20216263

(51) Int. Cl. H04B 7/06; H04B 7/08; H04W 36/00

(52) U.S. Cl. CPC H04B 7/0617; H04B 7/088; H04W 36/0058

(57) ABSTRACT

According to an example aspect of the present invention, there is provided an apparatus, such as a user equipment, configured to perform, in the user equipment, a measurement of at least one transmit beam of a cell using more than one directional receiving filter of the user equipment, determine a signal strength of the at least one transmit beam, in the measurement, separately via more than one of the directional receiving filters, and inform the cell or another cell whether the signal strength of the at least one transmit beam is detected separately via more than one of the directional receiving filters, at a receive signal strength which exceeds a threshold.

### FIELD

The present disclosure pertains to wireless communication systems.

### BACKGROUND

In wireless communication systems which comprises nodes capable of directionally selective transmission and reception, alignment of a transmit beam with a receive beam provides an optimized arrangement for communication in the sense that information may be conveyed using a smaller amount of energy, since less energy is radiated to directions from where the receiver cannot recover it, and also the receiver is selective to incoming radiation from the direction of the transmit beam, thus admitting less noise into the receiver.

A directionally selective receiver may be implemented by providing active antenna elements, for example. User equipments, UEs, of cellular systems, such as long term evolution, LTE, or fifth generation, 5G, may have plural active antenna elements in each of plural antenna panels of the UE, for example.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core, at least one memory including computer program code, the at least one memory and the computer program code being configured to, with the at least one processing core, cause the apparatus at least to perform, in a user equipment, a measurement of at least one transmit beam of a cell using more than one directional receiving filter of the user equipment, determine a signal strength of the at least one transmit beam, in the measurement, separately via more than one of the directional receiving filters, and inform the cell or another cell whether the signal strength of the at least one transmit beam is detected separately via more than one of the directional receiving filters, at a receive signal strength which exceeds a threshold.

According to a second aspect of the present disclosure, there is provided an apparatus comprising at least one processing core, at least one memory including computer program code, the at least one memory and the computer program code being configured to, with the at least one processing core, cause the apparatus at least to receive, from a user equipment, an indication of whether a signal strength of at least one transmit beam is detected, at the user equipment, separately via more than one directional receiving filter at a receive signal strength which exceeds a threshold, and select a cell for handover of the user equipment based at least in part on the received indication, such that in the selected cell the at least one transmit beam is received separately via more than one directional receiving filter at the receive signal strength which exceeds the threshold.

According to a third aspect of the present disclosure, there is provided an apparatus comprising at least one processing core, at least one memory including computer program code, the at least one memory and the computer program code being configured to, with the at least one processing core, cause the apparatus at least to receive, from a base station serving a user equipment, an indication of whether a signal strength of at least one transmit beam transmitted by the apparatus is detected, at the user equipment, separately via more than one directional receiving filter at a receive signal strength which exceeds a threshold, and select a cell, controlled by the apparatus, for handover of the user equipment based at least in part on the received indication, such that in the selected cell the at least one transmit beam is received at more than one directional receiving filter at the receive signal strength which exceeds the threshold.

According to a fourth aspect of the present disclosure, there is provided a method comprising performing, in a user equipment, a measurement of at least one transmit beam of cell using more than one directional receiving filter of the user equipment, determining a signal strength of the at least one transmit beam in the measurement, separately via more than one of the directional receiving filters, and informing the cell or another cell whether the signal strength of the at least one transmit beam is detected separately via more than one of the directional receiving filters, at a receive signal strength which exceeds a threshold.

According to a fifth aspect of the present disclosure, there is provided a method, comprising receiving, from a user equipment, an indication whether a signal strength of at least one transmit beam of a cell is detected, at the user equipment, separately via more than one directional receiving filter at a receive signal strength which exceeds a threshold, and selecting a cell for handover of the user equipment based at least in part on the received indication, such that in the selected cell the at least one transmit beam is received separately via more than one directional receiving filter at the receive signal strength which exceeds the threshold.

According to a sixth aspect of the present disclosure, there is provided a method, comprising receiving, in an apparatus, from a base station serving a user equipment, an indication of whether a signal strength of at least one transmit beam transmitted by the apparatus is detected, at the user equipment, separately via more than one directional receiving filter at a receive signal strength which exceeds a threshold, and selecting a cell, controlled by the apparatus, for handover of the user equipment based at least in part on the received indication, such that in the selected cell the at least one transmit beam is received at more than one directional receiving filter at the receive signal strength which exceeds the threshold.

According to a seventh aspect of the present disclosure, there is provided an apparatus comprising means for performing, in a user equipment, a measurement of at least one transmit beam of a cell using more than one directional receiving filter of the user equipment, determining a signal strength of the at least one transmit beam, in the measurement, separately via more than one of the directional receiving filters, and informing the cell or another cell whether the signal strength of the at least one transmit beam is detected separately via more than one of the directional receiving filters, at a receive signal strength which exceeds a threshold.

According to an eighth aspect of the present disclosure, there is provided an apparatus comprising means for receiving, from a user equipment, an indication whether a signal strength of at least one transmit beam of a cell is detected, at the user equipment, separately via more than one directional receiving filter at a receive signal strength which exceeds a threshold, and selecting a cell for handover of the user equipment based at least in part on the received indication, such that in the selected cell the at least one transmit beam is received separately via more than one directional receiving filter at the receive signal strength which exceeds the threshold.

According to a ninth aspect of the present disclosure, there is provided an apparatus comprising means for receiving, in an apparatus, from a base station serving a user equipment, an indication of whether a signal strength of at least one transmit beam transmitted by the apparatus is detected, at the user equipment, separately via more than one directional receiving filter at a receive signal strength which exceeds a threshold, and selecting a cell, controlled by the apparatus, for handover of the user equipment based at least in part on the received indication, such that in the selected cell the at least one transmit beam is received at more than one directional receiving filter at the receive signal strength which exceeds the threshold.

According to a tenth aspect of the present disclosure, there is provided a non-transitory computer readable medium having stored thereon a set of computer readable instructions that, when executed by at least one processor, cause an apparatus to at least perform, in a user equipment, a measurement of at least one transmit beam of cell using more than one directional receiving filter of the user equipment, determine a signal strength of the at least one transmit beam, in the measurement, separately via more than one of the directional receiving filters, and inform the cell or another cell whether the signal strength of the at least one transmit beam is detected separately via more than one of the directional receiving filters, at a receive signal strength which exceeds a threshold.

According to an eleventh aspect of the present disclosure, there is provided a non-transitory computer readable medium having stored thereon a set of computer readable instructions that, when executed by at least one processor, cause an apparatus to at least receive, from a user equipment, an indication whether a signal strength of at least one transmit beam of a cell is detected, at the user equipment, separately via more than one directional receiving filter at a receive signal strength which exceeds a threshold, and select a cell for handover of the user equipment based at least in part on the received indication, such that in the selected cell the at least one transmit beam is received separately via more than one directional receiving filter at the receive signal strength which exceeds the threshold.

According to a twelfth aspect of the present disclosure, there is provided a computer program configured to cause an apparatus to perform at least the following, when run: perform, in a user equipment, a measurement of at least one transmit beam of a cell using more than one directional receiving filter of the user equipment, determine a signal strength of the at least one transmit beam, in the measurement, separately via more than one of the directional receiving filters, and inform the cell whether the signal strength of the at least one transmit beam is detected separately via more than one of the directional receiving filters, at a receive signal strength which exceeds a threshold.

According to a thirteenth aspect of the present disclosure, there is provided a computer program configured to cause an apparatus to perform at least the following, when run: receive, from a user equipment, an indication whether a signal strength of at least one transmit beam of a cell is detected, at the user equipment, separately via more than one directional receiving filter at a receive signal strength which exceeds a threshold, and select a cell for handover of the user equipment based at least in part on the received indication, such that in the selected cell the at least one transmit beam is received separately via more than one directional receiving filter at the receive signal strength which exceeds the threshold.

According to a fourteenth aspect of the present disclosure, there is provided a computer program configured to cause a method in accordance with the sixth aspect to be performed, when run, and a non-transitory computer readable medium having stored thereon a set of computer readable instructions which constitute said computer program.

### BRIEF DESCRIPTION OF THE DRAWINGS

FIG. 1A illustrates an example system in accordance with at least some embodiments of the present invention;

FIG. 1B illustrates an example system in accordance with at least some embodiments of the present invention;

FIG. 2 illustrates an example situation illustrating the functioning of at least some embodiments of the present invention;

FIG. 3 illustrates an example apparatus capable of supporting at least some embodiments of the present invention;

FIG. 4 illustrates signalling in accordance with at least some embodiments of the present invention;

FIG. 5 is a flow graph of a method in accordance with at least some embodiments of the present invention, and

FIG. 6 is a flow graph of a method in accordance with at least some embodiments of the present invention.

### EMBODIMENTS

As disclosed herein, a user equipment, UE, may determine an extent to which beams of a cell such as a serving, neighbouring, candidate or target cell are received, in the UE, in more than one antenna panel, or more generally in more than one directional receiving filter. Owing to the fact that a single panel, or filter, may be inadvertently obstructed by the user's hand or head, a cell from which the UE can dependably receive signals using more than one panel or filter provides a more promising prospect for stable communications than a cell where signals from the cell are preponderantly received over a single panel or filter. The UE may notify a serving cell of this determined extent, to enable the network to take into account the actual, measured receive diversity at the UE when selecting a target cell for a handover for the UE, for example. Informing concerning the extent may comprise letting the serving cell know whether the signal strength of the at least one transmit beam is detected separately via more than one of the directional receiving filters, at a receive signal strength which exceeds a threshold The network may select the target cell at least in part depending on the measured receive diversity at the UE. The receive diversity may thus amount to antenna panel diversity or, more generally, directional receiving filter diversity.

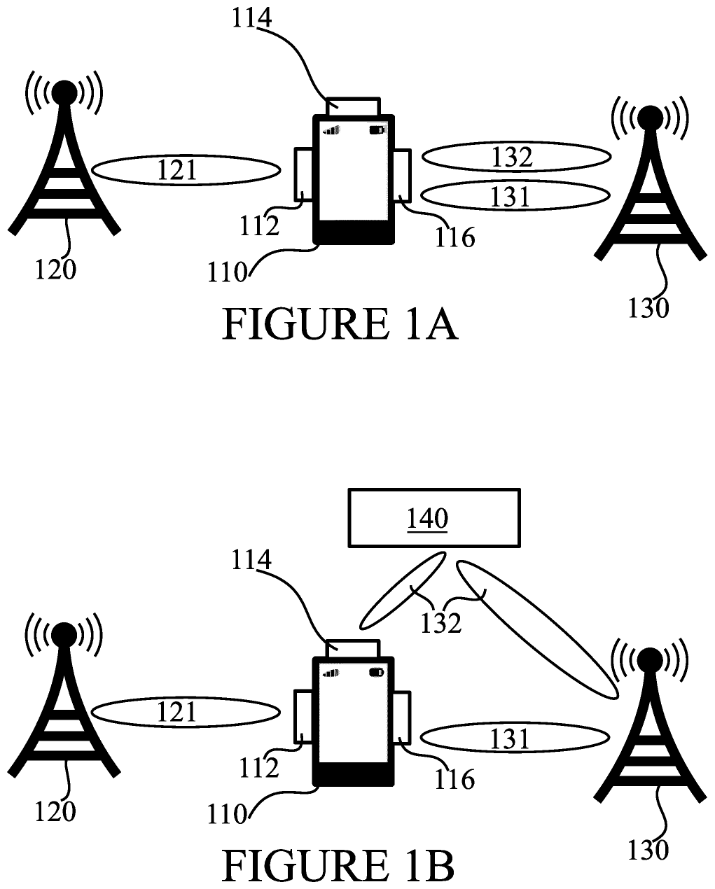

FIG. 1A illustrates an example system in accordance with at least some embodiments of the present invention. UE 110 may comprise a smartphone, a cell phone, a tablet computer, a laptop computer, a machine-to-machine device, an Internet of Things, IoT, device, and/or a connected car communications module, or another suitable electronic device, for example. UE 110 is in communication with a serving cell, which is controlled by base station 120, via beam 121. Base station is hereby selected as a terminological choice, by which it is not intended to limit applicability of the present disclosure to any specific wireless communication technology. Indeed, the herein disclosed mechanism may be employed in a range of wireless technologies, such as suitable cellular or non-cellular wireless systems. Examples of cellular systems include LTE and 5G, while examples of non-cellular systems include wireless local area network, WLAN, and worldwide interoperability of microwave access, WiMAX. In 5G a base station may be referred to as a gNB, whereas in LTE a base station may be known as an eNB. An access node in WLAN may be known as an access point. In detail, the context may be millimetre wave range, known in the 3^{rd} generation partnership project, 3GPP, as frequency range 2, FR2. This band involves operating bands between 24250 MHz and 43500 MHz.

Base station 120, and base station 130, are connected with further nodes, which are not illustrated in FIG. 1A for the sake of clarity. Examples of such further nodes include switching centres, routers, network exposure functions, NEFs, mobility management entities, MMEs, gateways, and access and mobility management functions, AMFs. The exact functions and names of such nodes depend on the networking technologies in use.

UE 110 of FIG. 1A has three antenna panels 112, 114 and 116. A transmit beam 121 of serving base station 120 is received, predominantly, in antenna panel 112. UE 110 may be capable of varying an angular breadth of its receive beams using active antenna elements of each antenna panel 112, 114 and 116. For example, searching for a transmit beam may be a three-phase process where a broad receive beam is used first, then an intermediate-breadth receive beam and finally a narrow receive beam is used for communication, once a transmit beam from a base station is identified.

UE 110 is arranged to receive service from the serving cell, for example, the service may comprise paging and active data communication, for example conversational media sessions, web browsing and/or transfers of digital files. A non-serving cell, such as one controlled by base station 130, may be a neighbouring cell, a candidate cell or a target cell. For example, a non-serving cell may be among candidates or potential candidates to become a target cell in a handover process, as a response to UE 110 moving toward an edge of the serving cell. As a result of a handover, a non-serving cell becomes a serving cell. In some scenarios, such as soft handover, there may be more than one serving cell at a time serving UE 110. A base station may control more than one cell, for example, a sectored base station may control plural cells which are separated from each other directionally, and/or a base station may control plural cells operating at different frequencies.

The non-serving cell controlled by base station 130 provides transmit beams, from among two, beam 131 and beam 132, are schematically illustrated in FIG. 1A. The beams may, in general, comprise synchronization signal block, SSB, beams, for example. UE 110 may have detected these beams in a sweep, searching for potential cells for handover, for example. Both beams 131 and 132 are received in UE 110 predominantly via antenna panel 116. In case these beams are strong, or even if only one of them is strong at UE 110, that is, received at UE 110 at a receive strength which exceeds a threshold, UE 110 may report to the serving cell that the cell of base station 130 is a good candidate for handover.

FIG. 1B illustrates an example system in accordance with at least some embodiments of the present invention. The situation in FIG. 1B resembles that in FIG. 1A, and like numbering denotes like structure as in FIG. 1A. In FIG. 1B, transmit beam 132 from base station 130 is reflected off building 140, such that this transmit beam is received in UE 110 most strongly via antenna panel 114. The reflected leg of transmit beam 132 is weaker than the leg originating directly at base station 130, but easily strong enough to be detectable and usable by UE 110. Beam 132 may also be detectable at antenna panel 116, at a different, for example lower, received signal power.

As was the case in FIG. 1A, beams 131 and 132 are received in UE 110 at a receive strength which exceeds a threshold, and UE 110 may report to the serving cell that the cell of base station 130 is a good candidate for handover. However, in the case of FIG. 1B, the cell of base station 130 is an even better candidate for handover, since transmit beams 131, 132 of this cell are strongly received over not only one, but two of the antenna panels of UE 110. Thus the situation in FIG. 1B has receive diversity in UE 110 with respect to beam 132. This is advantageous, since an individual antenna panel is vulnerable to being blocked by an object close to UE 110. A good example of such an object is simply the user's hand, which may cover antenna panel 116, potentially cutting off beams 131 and 132 in the arrangement of FIG. 1A. Whether the beams can penetrate a hand depends on their frequency and amplitude. Other examples of objects capable of blocking an antenna panel include the user's head, a book placed on UE 110, or when UE 110 is integrated in a car, for example, a rock or building next to which the car is parked.

It therefore provides a technical advantage, if a handover decision or other network action, such as resource selection for random access, is based not only on a signal strength, or signal strengths, measured from a potential handover target cell, but also on an extent to which receive diversity is used in receiving these signals at the UE, which as noted above may comprise transmit beams. In general, instead of antenna panel diversity, diversity obtained from using plural directional receive filters may provide directional receive diversity. A signal received via an antenna panel is received over a directional receive filter since antenna panels are directional and comprise filters. Further, a receive beam may be considered a directional receive filter.

In detail, using the extent to which the signals from the potential target cell are received over more than one directional receiving filter is beneficial as the likelihood of connection interruption in that cell is lower since the link to the base station is more resilient against blockage of a single directional receiving filter, such as an antenna panel. Expressed in other words, whether the signal strength of the at least one transmit beam is detected separately via more than one of the directional receiving filters of the UE, at a receive signal strength which exceeds a threshold, is a concrete measure of the extent to which the signals from the potential target cell are received over more than one directional receiving filter, and thus of the directional receive diversity. The larger is the distribution of the received signal strength over more than one directional receiving filter, the larger is the effective directional receive diversity.

The UE may further be configured to select a transmit beam from among the at least one transmit beam of the non-serving cell and to use the selected transmit beam for a random access process in that cell, such as the transmission of a random access preamble, the selecting being based at least in part on a number of directional receiving filters of UE 110 at which the selected transmit beam is detectable at a received signal strength exceeding a selection threshold. In particular, the UE may be configured to select the beam received over the largest number of directional receiving filters, or at least to preferentially select a beam with higher directional receive diversity.

UE 110 may inform the serving cell of the determined extent to which the at least one transmit beam of the non-serving cell is detected via more than one of the directional receiving filters of the UE using one of several signalling options. As a first option, the UE may indicate to the serving cell whether a specific transmit beam of the potential target cell, or at least one of its transmit beams, is received using more than one of the directional receiving filters at a receive strength which exceeds a threshold. In other words, in the first option, the UE may simply indicate whether at least one beam is received from the cell with directional receive diversity, such as directional antenna panel diversity. As a second option, the UE may indicate whether directional receive diversity, such as directional antenna panel diversity, is present for plural transmit beams of the potential target cell. In other words, the UE in the second option might indicate if at least two beams are received using at least two antenna panels. If so, it may comprise that at least one beam is received via two panels, and/or that one beam is received via one antenna panel and another beam is received via another antenna panel. In the second option, the UE may indicate to the serving cell a number of the directional receiving filters which via which the transmit beams from the potential target cell are received, to enable the network to more dependably rank potential cells for handover. In the first and second options, the threshold defining whether a transmit beam is received via a specific directional receiving filter may be received from the network with which the user equipment is attached, or the threshold may be statically defined in the UE, such as from specifications or as a factory configuration.

As a third option, the UE may inform the serving cell of an average of received signal strengths of the transmit beams in at least two of the directional receiving filters. In this third option, also an overall beam receive signal strength is reported to the serving cell for each beam, whereby the network is enabled to detect, where a certain beam has a higher overall beam receive signal strength than the average over K antenna panels, this implying that the beam is dependably present in perhaps only one antenna panel and thus vulnerable to panel blockage.

The first option will now be described in more detail. In this option, the UE reports for each layer-3, L3, beam measurement included in a measurement report provided to the serving cell, whether the beam is received on one or more than one directional receiving filter. The indication may take the form of a Boolean value simply to indicate whether the beam is detected, stronger than the threshold, at one or plural directional receiving filters. The indication may take the value “0” or “1”, respectively. Alternatively, the indication can take a form of integer value where the UE indicates the number of directional receiving filters on which the beam is detected at a received signal strength in excess of the threshold, for example “1” if beam is received sufficiently via a single directional receiving filter and “2” if the beam is received in excess of the threshold via two separate directional receiving filters, such as antenna panels. The threshold itself may be absolute or relative. In case the threshold is relative, it may be expressed as a proportion of a strongest beam, for example. Whether absolute or relative, the threshold may be signalled from the network, or be statically defined in the UE.

An example measurement report the UE uses to inform the serving cell may look like the following in the first signalling option:
Measurement report: Target cell X: SSB3, RSRP −95 dBm, Panel diversity indicator “1”

Here SSB refers to a synchronization signal block, RSRP to received signal receive power and the diversity indicator informs the network whether beam SSB3 is detectable in excess of the threshold in one, or more than one, directional receiving filter, such as antenna panel. In this example, there is diversity and SSB3 appears therefore to be a promising beam. A similar example where beam SSB3 is detectable in only one directional receiving filter is:
Measurement report: Target cell X: SSB3, RSRP −95 dBm, Panel diversity indicator “0”

The second option will now be described in more detail. In this option, the UE reports an indication in the measurement report related to a non-serving cell whether the different beam(s) are sufficiently received on the same or on multiple UE directional receiving filter. As in the first option, this indication may take the form of a simple Boolean indicator to indicate whether a single, or plural, directional receiving filter detected the beam(s) with a strength exceeding the threshold. Alternatively to the Boolean indicator, an integer indicator may be provided to define the number of directional receiving filters at which the beam(s) is receivable at a strength exceeding the threshold. In one example, the Boolean or integer indication can be for a subset of the target beams. In this case, different subsets of target beams can have different integer values. In another example, the UE may indicate the number of directional receiving filters that are used for the cell quality derivation. In other words, the number of directional receiving filters from the beam measurements that UE reports are taken to perform beam consolidation used in cell quality derivation.

An example measurement report the UE uses to inform the serving cell may look like the following in the second signalling option:
Measurement report: Target cell X: RSRP −94.8 dBm, Panel diversity indicator “1”
   for the Boolean option, or with an integer indicator:
Measurement report: Target cell X: RSRP −94.8 dBm, Panels=2
   to indicate a situation with directional receive diversity. For a poor-diversity situation, the example reports may appear as follows:
Measurement report: Target cell X: RSRP −94.8 dBm, Panel diversity indicator “0”
   for the Boolean option, and for the integer indicator:
Measurement report: Target cell X: RSRP −94.8 dBm, Panels=1.

The third signalling option will now be described in more detail. In this option, the UE reports, in addition to measurements which comprise integrated receive strengths for each beam, the average (which may be an arithmetic or weighted average, for example) of target beam measurement over an integer “K” UE directional receiving filters. K can be configured by the network, indicated in the specifications, or left for UE implementation, for example. The network can compare the reported integrated beam strength measurement with the average value over K directional receiving filters to determine the level of robustness to single-panel obstruction. For instance, if the average value is much smaller than the reported integrated beam strength measurement, the network can infer that the target cell may not be robust against blockages (and vice-versa), thus dependably evaluating the directional robustness of the target beam.

An example measurement report UE 110 uses to inform the serving cell may look like the following in the third signalling option:
Measurement report: Target cell X:
Beam 3, RSRP −96.2, (K=2),
Beam 2, RSRP −93, (K=1)
   where K is the number of directional receiving filters used for the respective beam, over which the reported receives signal strength, RSRP, is averaged.

In a handover process, the new indications about the directional receive diversity concerning the target beams, informed from UE 110 to source base station 120, may be forwarded from the source base station 120 to target base station 130 over an inter-base station interface, such as an Xn interface. The target base station may use this indication for contention-free random access, CFRA, resource allocation, for example. In detail, CFRA resources may be allocated preferentially to beams with directional receive diversity in the UE, to make the random access processes more resilient against failure. The UE may likewise select the strongest beam, in terms of directional receiving filter diversity, for transmission of a random access preamble in the selected target cell. Thus both UE and base station may select the same beam for a random access process, based on the same criteria.

Overall, concerning the first, second and third signalling options, the first and second options may be combined in that the report provided to the serving cell may comprise both kinds of indications. The third option, further, may be combined with the second option.

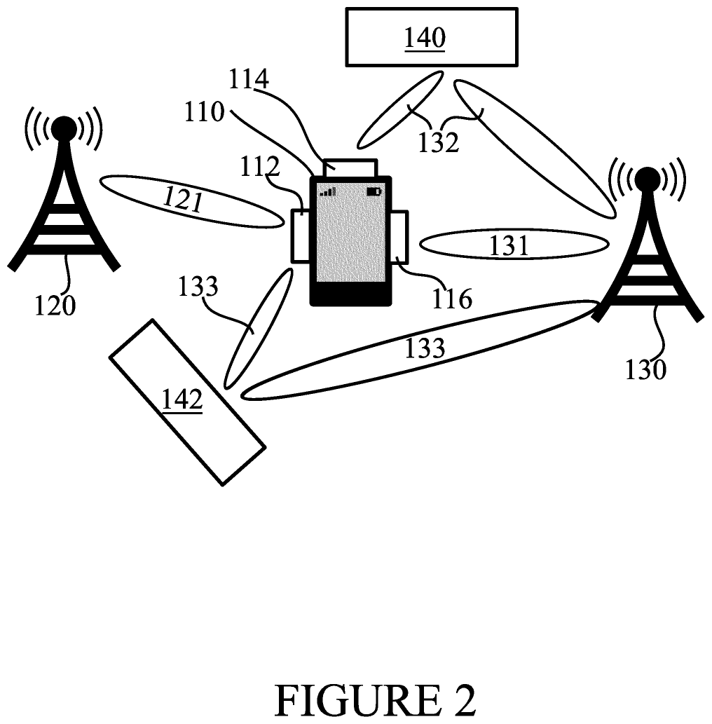

FIG. 2 illustrates an example situation illustrating the functioning of at least some embodiments of the present invention. The situation in FIG. 2 resembles that of FIG. 1B, with the difference that a third transmit beam 133 of base station 130 is also illustrated, this beam reaching antenna panel 112 via building 142, from which this beam is reflected. As is the case with beam 132, also for beam 133 the reflected leg of the beam is weaker than the initial leg, however strong enough to be dependably received in antenna panel 112.

The following table below shows measurements of beams 131, 132 and 133 on each of UE antenna panels 112, 114 and 116. Here, the cell of base station 130 is received on a main lobe of antenna panel 116, side lobes of antenna panel 114 (for example 15 dB lower gain than main lobe) and a back lobe of antenna panel 112 (for example 25 dB lower gain than main lobe). Two reflectors 140, 142 provide high RSRP values for beam 132 on antenna panel 114 and beam 133 on antenna panel 112.

| | Beam 133 | | Beam 131 | | Beam 132 | |
|---|---|---|---|---|---|---|
| Antenna panel 114 | −112 | dBm | −108 | dBm | −98 | dBm |
| Antenna panel 112 | −100 | dBm | −118 | dBm | −120 | dBm |
| Antenna panel 116 | −97 | dBm | −93 | dBm | −95 | dBm |

Integer N may be set as the number of strongest beam measurements to be used in deriving a cell quality measurement. If the UE is configured by the network to report an averaged cell quality measurement with N=3 strongest target beam measurements, it would, in the absence of the receive diversity indication disclosed in the present document, in this numerical example report 94.7 dBm, which is the average after linear conversion and averaging of −97 dBm for beam 133, −93 dBm for beam 131 and −95 dBm for beam 132. In addition, the measurement report may include the strongest beam measurements, namely beam 133: −97 dBm, beam 131: −93 dBm and beam 132: −95 dBm. Therefore, the base station is not informed of the UE receive antenna panel diversity of the target beams, in particular, the base station would not be informed that all the reported measurements in this example originate in the same antenna panel 116.

In the first signalling option described above, the UE may indicate additionally whether a target beam is received sufficiently on multiple panels, for example whether a measured signal strength>threshold, where threshold is equal to −101 dBm, for example. That is, beam 133 is multiple panels (2 panels), beam 131 on a single panel and beam 132 on multiple panels (2 panels).

In the second signalling option described above, the UE may indicate additionally that beams 131, 132 and 133 are received sufficiently on different panels, that is, antenna panel 114 (−98 dBm for beam 132), antenna panel 112 (−100 dBm for beam 133) and antenna panel 116 (for all three beams) as shown in the table above.

In the third signalling option described above, the UE may indicate additionally the average of beam measurement over K UE panels. In this example, a) the linear average of beam 133 measurement over K (e.g. 2) antenna panels with strongest measurement (antenna panels 112 and 116) which is −98.2 dBm, b) the linear average of beam 131 measurement over K (e.g. 2) panels with strongest measurement (antenna panels 114 and 116) which is −95.9 dBm and c) the linear average of beam 132 measurement over K (e.g. 2) panels with strongest measurement (antenna panels 114 and 116) which is −96.2 dBm.

From the above-mentioned average values in the third signalling option, in comparison with strongest beam measurements, the network can infer that: beams 133 and 132 are well received plural panels as the average value does not deviate much from the strongest reported values (beam 133: average −98 dBm vs strongest −97 dBm and beam 132: average −96 dBm vs strongest −95 dBm).

Therefore, the target cell is a robust cell against blockage of an antenna panel as at least two beams are sufficiently well received on UE by at least two panels, and also, beams 133 and 132 are robust CFRA candidates in the target cell.

On the other hand, beam 131 is not received very well on other panels as the average value −96 dBm deviates by roughly 3 dB from the strongest beam measurement −93 dBm, that is, 3 dB deviation in average value from the strongest beam measurement is a significant difference which means the beam is not received well on other UE antenna panels. Therefore, beam 131 is not a robust target beam and should not be prioritized as a CFRA resource.

In some embodiments, in general, the base station may enable and disable, by signalling, the UE reporting of the extent to which the at least one transmit beam is detected via more than one of the directional receiving filters. The UE receive diversity measurements described herein provide the network with information about the robustness of the non-serving cell by enabling antenna panel diversity related metrics. The source cell may use these metrics in target cell selection for handover, for example, it may preferentially select a target cell where target beams are received on multiple panels. Concretely, from the network perspective, it may be a better choice to switch to a cell where the UE detects N=2 on two panels (where N is the number of detectable target-cell transmit beams used in a measurement report) than N=5 beams on a single panel, since the single panel may be blocked by an object close to the UE. In other words, diversity of beams as such may be less useful than directional receive diversity, which provides resilience against blocked antenna panels. Furthermore, the source cell may forward the proposed information to the selected target cell such that the target cell may use it for CFRA resource selection for the UE. For example, it may optimize physical random access channel, PRACH, resources by only selecting beams with strong UE panel diversity for CFRA configuration. As noted above, in general, whether the signal strength of the at least one measured transmit beam is detected separately via more than one of the directional receiving filters of the UE, at a receive signal strength which exceeds a threshold, is an expression of the extent to which the at least one transmit beam is detected via more than one of the directional receiving filters.

In some embodiments, the UE may perform the selecting of the target cell, based on the extent to which the at least one transmit beam is detected via more than one of the directional receiving filters, such that the UE preferentially chooses a cell where the extent at which the at least one transmit beam is detected via more than one of the directional receiving filters is higher.

Concerning technical benefits of the disclosed mechanism, the UE panel diversity reporting of target beams enables a source cell to enhance target cell selection for handovers. Furthermore, when this information is forwarded to the target cell, it enhances target beam selection for CFRA resources. The proposed mechanism also finds application in layer-1, L1, inter-cell mobility and in multi-transmission reception point (multi-TRP) scenarios.

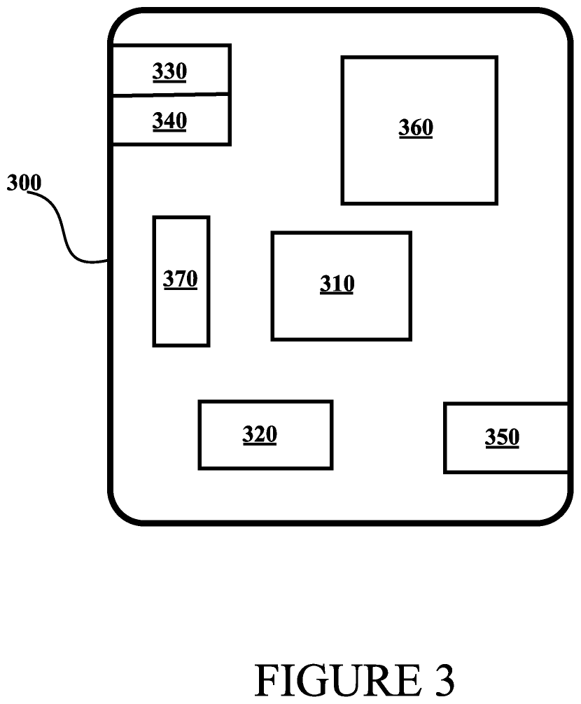

FIG. 3 illustrates an example apparatus capable of supporting at least some embodiments of the present invention. Illustrated is device 300, which may comprise, for example, a mobile communication device such as mobile 110 of FIG. 1A or FIG. 1B. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Zen processing core designed by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300. Processor 310 may be configured, at least in part by computer instructions, to perform actions, such as performing, determining, informing, transmitting, selecting and receiving.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as a mobile phone or network node, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games. Where device 300 is a base station, the user interface may be used to configure reporting parameters, for example.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

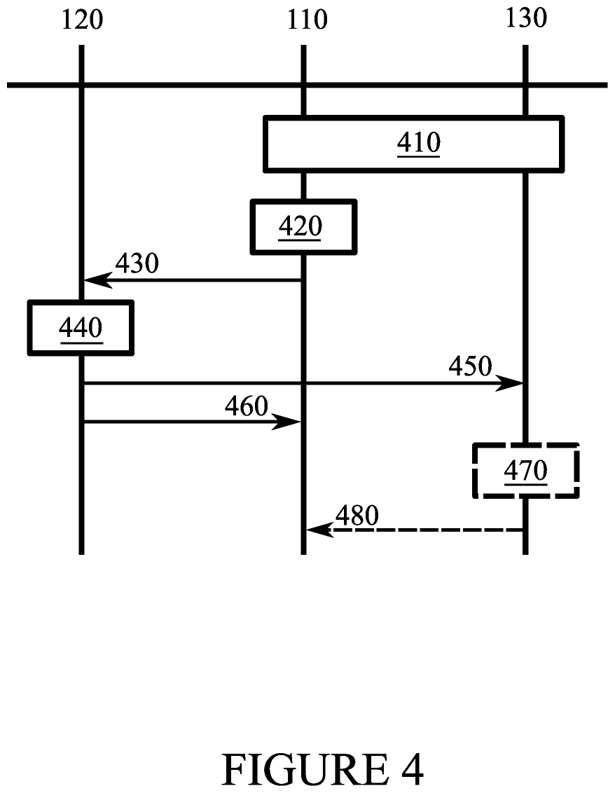

FIG. 4 illustrates signalling in accordance with at least some embodiments of the present invention. On the vertical axes are disposed, on the left, base station 120, in the centre, UE 110 and on the right, base station 130 as depicted in FIGS. 1A, 1B and 2. Time advances from the top toward the bottom. Base station 120 controls a serving cell of the UE.

In phase 410 the UE measures transmitted beams of base station 130, as described herein above. The beams may, in general, comprise synchronization signal block, SSB, beams, for example. The UE measures a received signal strength of the beam(s) it detects using more than one directional receiving filter, such as more than one antenna panel, for example.

In phase 420, the UE determines an extent to which the at least one transmit beam is detected, in the measurement, via more than one of the directional receiving filters. This amounts to determining an extent of directional receive diversity for the beams. The UE informs the serving cell of the determined extent of directional receive diversity in phase 430.

Progressing to phase 440, here base station 120 processes the information received in phase 430 from the UE. For example, base station 120 may select the cell of base station 130, measured in phase 410, as a target cell for handover based on the extent of directional receive diversity, as described herein above. In case base station 120 selects the cell measured in phase 410 as a target cell for handover, it may provide the information it received from the UE in phase 430 to the target cell, phase 450. It may also inform the UE that a it should undergo a handover to the chosen cell, phase 460. Phases 450 and 460 may take place in either order, phase 450 first or phase 460 first, or these phase may take place simultaneously. Phase 450 may take place over an inter-base station interface, such as an Xn interface, for example.

In phase 470, base station 130 may select a transmit beam of the target cell as a CFRA resource based at least in part on the receive diversity information it received in phase 450. In particular, a beam with a higher extent of receive diversity than other beams may be selected as the CFRA resource. The UE may be informed of the selection in phase 480. Phases 470 and 480 are optional.

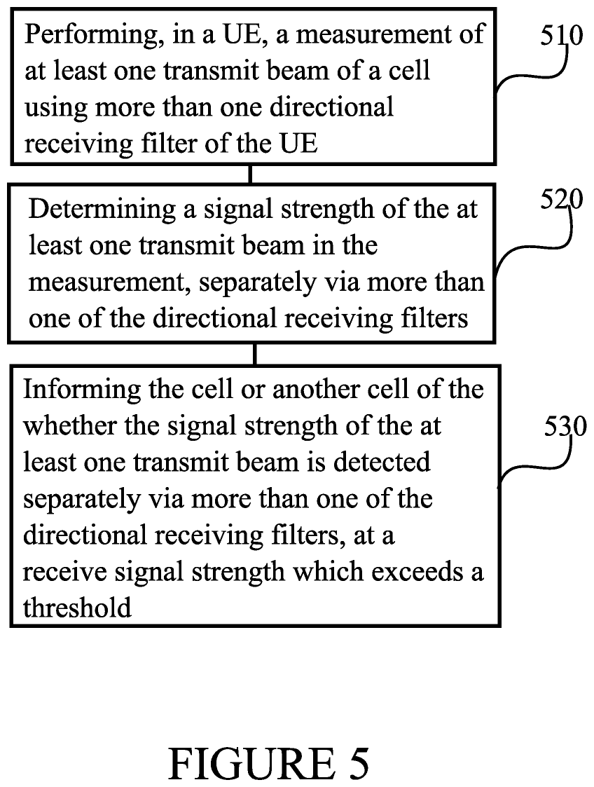

FIG. 5 is a flow graph of a method in accordance with at least some embodiments of the present invention. The phases of the illustrated method may be performed in device 110, an auxiliary device or a personal computer, for example, or in a control device configured to control the functioning thereof, when installed therein.

Phase 510 comprises performing, in a user equipment, a measurement of at least one transmit beam of cell using more than one directional receiving filter of the user equipment. The cell may be a non-serving cell, for example. Phase 520 comprises determining a signal strength of the at least one transmit beam in the measurement, separately via more than one of the directional receiving filters. Phase 530 comprises informing the cell or another cell whether the signal strength of the at least one transmit beam is detected separately via more than one of the directional receiving filters, at a receive signal strength which exceeds a threshold. If the same cell is informed as was measured in phase 510, this may be the serving cell. In case another cell is informed in phase 530, the cell measured in phase 510 may be a non-serving cell and the another cell which is informed in phase 530 may be the serving cell.

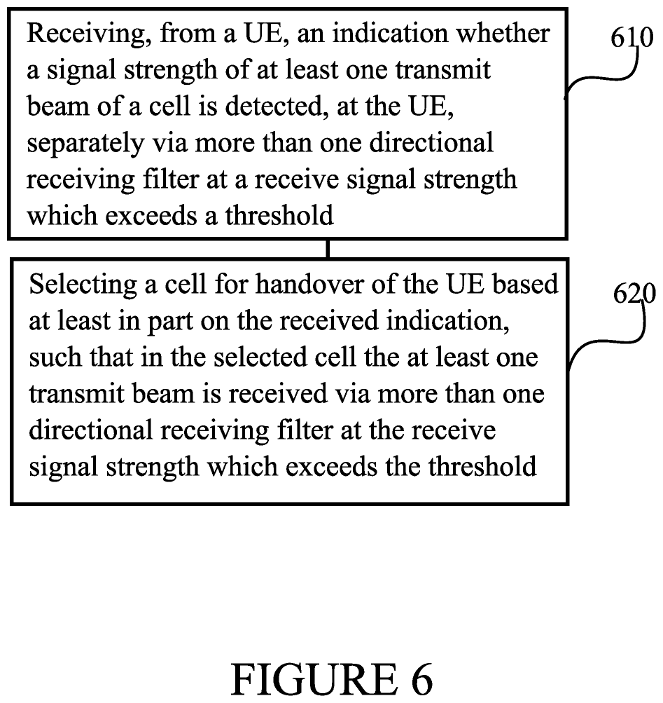

FIG. 6 is a flow graph of a method in accordance with at least some embodiments of the present invention. The phases of the illustrated method may be performed in device 110, an auxiliary device or a personal computer, for example, or in a control device configured to control the functioning thereof, when installed therein.

Phase 610 comprises receiving, from a user equipment, an indication whether a signal strength of at least one transmit beam of a cell is detected, at the user equipment, separately via more than one directional receiving filter at a receive signal strength which exceeds a threshold. Phase 620 comprises selecting a cell for handover of the user equipment based at least in part on the received indication, such that in the selected cell the at least one transmit beam is received separately via more than one directional receiving filter at the receive signal strength which exceeds the threshold. The cell may be a non-serving cell, for example.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### Industrial Applicability

At least some embodiments of the present invention find industrial application in operating wireless communication networks.

### Technical Clauses

Clause 1. An apparatus comprising at least one processing core, at least one memory including computer program code, the at least one memory and the computer program code being configured to, with the at least one processing core, cause the apparatus at least to:
perform, in a user equipment, a measurement of at least one transmit beam of a cell using more than one directional receiving filter of the user equipment;
determine a signal strength of the at least one transmit beam, in the measurement, separately via more than one of the directional receiving filters, and
inform the cell or another cell whether the signal strength of the at least one transmit beam is detected separately via more than one of the directional receiving filters, at a receive signal strength which exceeds a threshold.

Clause 2. The apparatus according to Clause 1, wherein each one of the more than one directional receiving filter is associated with a distinct antenna panel of the user equipment.

Clause 3. The apparatus according to Clause 1, wherein each one of the more than one directional receiving filter is a directional receive beam of the user equipment.

Clause 4. The apparatus according to any of claims 1-3, wherein the apparatus is configured to perform the informing of the network cell by informing the network cell, whether a specific one of the at least one transmit beam is received in more than one of the directional receiving filters at the receive strength which exceeds the threshold.

Clause 5. The apparatus according to any of claims 1-4, wherein, when the at least one transmit beam comprises at least two transmit beams.

Clause 6. The apparatus according to Clause 5, configured to perform the informing of the network cell by informing the network cell, whether at least two of the transmit beams are received in at least two of the directional receiving filters, respectively, at a receive strength which exceeds the threshold.

Clause 7. The apparatus according to Clause 6, wherein the apparatus is configured to perform the informing by transmitting to the network cell an indication of a number of directional receiving filters via which the at least two transmit beams are received at the strength which exceeds the threshold.

Clause 8. The apparatus according to any of claims 1-7, wherein the apparatus is configured to receive the threshold from the network with which the user equipment is attached, or to statically store the threshold in the apparatus.

Clause 9. The apparatus according to any of claims 1-8, wherein the apparatus is configured to perform the informing of the network cell by informing the network cell of an average of received signal strengths of at least one transmit beam in at least two of the directional receiving filters, the received signal strengths being determined in the measurement.

Clause 10. The apparatus according to any of claims 1-9, wherein the apparatus is further configured to select a transmit beam from among the at least one transmit beam and to use the selected transmit beam for a random access process, the selecting being based at least on a number of directional receiving filters of the user equipment at which the selected transmit beam is detectable at a received signal strength exceeding a selection threshold.

Clause 11. The apparatus according to any of claims 1-10, wherein the apparatus is further configured to select a target cell from among at least two candidate target cells and to use the selected target cell for a handover procedure, the selecting being based at least on a number of directional receiving filters of the apparatus at which the selected transmit beam of a target cell is detectable at a received signal strength exceeding a selection threshold

Clause 12. An apparatus comprising at least one processing core, at least one memory including computer program code, the at least one memory and the computer program code being configured to, with the at least one processing core, cause the apparatus at least to:
receive, from a user equipment, an indication of whether a signal strength of at least one transmit beam is detected, at the user equipment, separately via more than one directional receiving filter at a receive signal strength which exceeds a threshold, and
select a cell for handover of the user equipment based at least in part on the received indication, such that in the selected cell the at least one transmit beam is received separately via more than one directional receiving filter at the receive signal strength which exceeds the threshold.

Clause 13. The apparatus according to Clause 12, wherein the apparatus is further configured to indicate to the cell selected for handover a specific transmit beam from among the at least one transmit beam for use as a contention free random access resource with the user equipment, the specific transmit beam being selected based on the specific transmit beam being received in the user equipment separately at more than one directional receiving filter at the receive signal strength which exceeds the threshold.

Clause 14. An apparatus comprising at least one processing core, at least one memory including computer program code, the at least one memory and the computer program code being configured to, with the at least one processing core, cause the apparatus at least to:
receive, from a base station serving a user equipment, an indication of whether a signal strength of at least one transmit beam transmitted by the apparatus is detected, at the user equipment, separately via more than one directional receiving filter at a receive signal strength which exceeds a threshold, and
select a cell, controlled by the apparatus, for handover of the user equipment based at least in part on the received indication, such that in the selected cell the at least one transmit beam is received at more than one directional receiving filter at the receive signal strength which exceeds the threshold.

Clause 15. The apparatus according to Clause 14, wherein the indication received from the base station serving the user equipment includes a list of candidate cells, each one of which is controlled by the apparatus, and separately for each one of the candidate cells an indication as to whether at least one transmit beam of the candidate cell is received in the user equipment separately at more than one directional receiving filter at the receive signal strength which exceeds the threshold.

Clause 16. A method comprising:
performing, in a user equipment, a measurement of at least one transmit beam of cell using more than one directional receiving filter of the user equipment;
determining a signal strength of the at least one transmit beam in the measurement, separately via more than one of the directional receiving filters, and
informing the cell or another cell whether the signal strength of the at least one transmit beam is detected separately via more than one of the directional receiving filters, at a receive signal strength which exceeds a threshold.

Clause 17. The method according to Clause 16, wherein each one of the more than one directional receiving filter is associated with a distinct antenna panel of the user equipment.

Clause 18. The method according to Clause 16, wherein each one of the more than one directional receiving filter is a directional receive beam of the user equipment.

Clause 19. The method according to any of claims 16-18, wherein the method comprises performing the informing of the network cell by informing the network cell, whether a specific one of the at least one transmit beam is received in more than one of the directional receiving filters at the receive strength which exceeds the threshold.

Clause 20. The method according to any of claims 16-19, wherein, when the at least one transmit beam comprises at least two transmit beams.

Clause 21. The method according to Clause 20, further comprising performing the informing of the network cell by informing the network cell, whether at least two of the transmit beams are received in at least two of the directional receiving filters, respectively, at a receive strength which exceeds the threshold.

Clause 22. The method according to Clause 21, wherein the method comprises performing the informing by transmitting to the network cell an indication of a number of directional receiving filters via which the at least two transmit beams are received at the strength which exceeds the threshold.

Clause 23. The method according to any of claims 16-22, wherein the threshold is received from the network with which the user equipment is attached, or statically defined in the apparatus.

Clause 24. The method according to any of claims 16-23, wherein the method comprises performing the informing of the network cell by informing the network cell of an average of received signal strengths of at least one transmit beam in at least two of the directional receiving filters, the received signal strengths being determined in the measurement.

Clause 25. The method according to any of claims 16-25, wherein the method further comprises selecting a transmit beam from among the at least one transmit beam and using the selected transmit beam in a random access process, the selecting being based at least on a number of directional receiving filters of the user equipment at which the selected transmit beam is detectable at a received signal strength exceeding a selection threshold.

Clause 26. A method, comprising:
receiving, from a user equipment, an indication whether a signal strength of at least one transmit beam of a cell is detected, at the user equipment, separately via more than one directional receiving filter at a receive signal strength which exceeds a threshold, and
selecting a cell for handover of the user equipment based at least in part on the received indication, such that in the selected cell the at least one transmit beam is received separately via more than one directional receiving filter at the receive signal strength which exceeds the threshold.

Clause 27. The method according to Clause 26, further comprising indicating to the cell selected for handover a specific transmit beam from among the at least one transmit beam for use as a contention free random access resource with the user equipment, the specific transmit beam being selected based on the specific transmit beam being received in the user equipment separately at more than one directional receiving filter at the receive signal strength which exceeds the threshold

Clause 28. A method, comprising:
receiving, in an apparatus, from a base station serving a user equipment, an indication of whether a signal strength of at least one transmit beam transmitted by the apparatus is detected, at the user equipment, separately via more than one directional receiving filter at a receive signal strength which exceeds a threshold, and
selecting a cell, controlled by the apparatus, for handover of the user equipment based at least in part on the received indication, such that in the selected cell the at least one transmit beam is received at more than one directional receiving filter at the receive signal strength which exceeds the threshold.

Clause 29. The method according to Clause 28, wherein the indication received from the base station serving the user equipment includes a list of candidate cells, each one of which is controlled by the apparatus, and separately for each one of the candidate cells an indication as to whether at least one transmit beam of the candidate cell is received in the user equipment separately at more than one directional receiving filter at the receive signal strength which exceeds the threshold.

Clause 30. An apparatus comprising means for:
performing, in a user equipment, a measurement of at least one transmit beam of a cell using more than one directional receiving filter of the user equipment;
determining a signal strength of the at least one transmit beam, in the measurement, separately via more than one of the directional receiving filters, and
informing the cell or another cell whether the signal strength of the at least one transmit beam is detected separately via more than one of the directional receiving filters, at a receive signal strength which exceeds a threshold.

Clause 31. An apparatus comprising means for:
receiving, from a user equipment, an indication whether a signal strength of at least one transmit beam of a cell is detected, at the user equipment, separately via more than one directional receiving filter at a receive signal strength which exceeds a threshold, and
selecting a cell for handover of the user equipment based at least in part on the received indication, such that in the selected cell the at least one transmit beam is received separately via more than one directional receiving filter at the receive signal strength which exceeds the threshold.

Clause 32. An apparatus comprising means for:
receiving, in an apparatus, from a base station serving a user equipment, an indication of whether a signal strength of at least one transmit beam transmitted by the apparatus is detected, at the user equipment, separately via more than one directional receiving filter at a receive signal strength which exceeds a threshold, and
selecting a cell, controlled by the apparatus, for handover of the user equipment based at least in part on the received indication, such that in the selected cell the at least one transmit beam is received at more than one directional receiving filter at the receive signal strength which exceeds the threshold.

Clause 33. A non-transitory computer readable medium having stored thereon a set of computer readable instructions that, when executed by at least one processor, cause an apparatus to at least:
perform, in a user equipment, a measurement of at least one transmit beam of cell using more than one directional receiving filter of the user equipment;
determine a signal strength of the at least one transmit beam, in the measurement, separately via more than one of the directional receiving filters, and
inform the cell or another cell whether the signal strength of the at least one transmit beam is detected separately via more than one of the directional receiving filters, at a receive signal strength which exceeds a threshold.

Clause 34. A non-transitory computer readable medium having stored thereon a set of computer readable instructions that, when executed by at least one processor, cause an apparatus to at least:
receive, from a user equipment, an indication whether a signal strength of at least one transmit beam of a cell is detected, at the user equipment, separately via more than one directional receiving filter at a receive signal strength which exceeds a threshold, and
select a cell for handover of the user equipment based at least in part on the received indication, such that in the selected cell the at least one transmit beam is received separately via more than one directional receiving filter at the receive signal strength which exceeds the threshold.

Clause 35. A computer program configured to cause an apparatus to perform at least the following, when run:
perform, in a user equipment, a measurement of at least one transmit beam of a cell using more than one directional receiving filter of the user equipment;
determine a signal strength of the at least one transmit beam, in the measurement, separately via more than one of the directional receiving filters, and
inform the cell whether the signal strength of the at least one transmit beam is detected separately via more than one of the directional receiving filters, at a receive signal strength which exceeds a threshold.

Clause 36. A computer program configured to cause an apparatus to perform at least the following, when run:
receive, from a user equipment, an indication whether a signal strength of at least one transmit beam of a cell is detected, at the user equipment, separately via more than one directional receiving filter at a receive signal strength which exceeds a threshold, and
select a cell for handover of the user equipment based at least in part on the received indication, such that in the selected cell the at least one transmit beam is received separately via more than one directional receiving filter at the receive signal strength which exceeds the threshold.

1. An apparatus comprising at least one processing core, at least one memory including computer program code, the at least one memory and the computer program code being configured to, with the at least one processing core, cause the apparatus at least to:
perform, in a user equipment, a measurement of at least one transmit beam of a cell using more than one directional receiving filter of the user equipment;
determine a signal strength of the at least one transmit beam, in the measurement, separately via more than one of the directional receiving filters, and
inform the cell or another cell whether the signal strength of the at least one transmit beam is detected separately via more than one of the directional receiving filters, at a receive signal strength which exceeds a threshold.

2. The apparatus according to claim 1, wherein each one of the more than one directional receiving filter is associated with a distinct antenna panel of the user equipment.

3. The apparatus according to claim 1, wherein each one of the more than one directional receiving filter is a directional receive beam of the user equipment.

4. The apparatus according to claim 1, wherein the apparatus is configured to perform the informing of the network cell by informing the network cell, whether a specific one of the at least one transmit beam is received in more than one of the directional receiving filters at the receive strength which exceeds the threshold.

5. The apparatus according to claim 1, wherein, when the at least one transmit beam comprises at least two transmit beams.

6. The apparatus according to claim 5, configured to perform the informing of the network cell by informing the network cell, whether at least two of the transmit beams are received in at least two of the directional receiving filters, respectively, at a receive strength which exceeds the threshold.

7. The apparatus according to claim 5, configured to perform the informing of the network cell by informing the network cell, whether at least two of the transmit beams are received in at least two of the directional receiving filters, respectively, at a receive strength which exceeds the threshold, wherein the apparatus is configured to perform the informing by transmitting to the network cell an indication of a number of directional receiving filters via which the at least two transmit beams are received at the strength which exceeds the threshold.

8. The apparatus according to claim 1, wherein the apparatus is configured to receive the threshold from the network with which the user equipment is attached, or to statically store the threshold in the apparatus.

9. The apparatus according to claim 1, wherein the apparatus is configured to perform the informing of the network cell by informing the network cell of an average of received signal strengths of at least one transmit beam in at least two of the directional receiving filters, the received signal strengths being determined in the measurement.

10. An apparatus comprising at least one processing core, at least one memory including computer program code, the at least one memory and the computer program code being configured to, with the at least one processing core, cause the apparatus at least to:
receive, from a user equipment, an indication of whether a signal strength of at least one transmit beam is detected, at the user equipment, separately via more than one directional receiving filter at a receive signal strength which exceeds a threshold, and
select a cell for handover of the user equipment based at least in part on the received indication, such that in the selected cell the at least one transmit beam is received separately via more than one directional receiving filter at the receive signal strength which exceeds the threshold.

11. An apparatus comprising at least one processing core, at least one memory including computer program code, the at least one memory and the computer program code being configured to, with the at least one processing core, cause the apparatus at least to:
receive, from a base station serving a user equipment, an indication of whether a signal strength of at least one transmit beam transmitted by the apparatus is detected, at the user equipment, separately via more than one directional receiving filter at a receive signal strength which exceeds a threshold, and
select a cell, controlled by the apparatus, for handover of the user equipment based at least in part on the received indication, such that in the selected cell the at least one transmit beam is received at more than one directional receiving filter at the receive signal strength which exceeds the threshold.

12-15. (canceled)

16. The apparatus according to claim 1, wherein the apparatus is further configured to select a transmit beam from among the at least one transmit beam and to use the selected transmit beam for a random access process, the selecting being based at least on a number of directional receiving filters of the user equipment at which the selected transmit beam is detectable at a received signal strength exceeding a selection threshold.

17. The apparatus according to claim 1, wherein the apparatus is further configured to select a target cell from among at least two candidate target cells and to use the selected target cell for a handover procedure, the selecting being based at least on a number of directional receiving filters of the apparatus at which the selected transmit beam of a target cell is detectable at a received signal strength exceeding a selection threshold.

18. The apparatus according to claim 10, wherein the apparatus is further configured to indicate to the cell selected for handover a specific transmit beam from among the at least one transmit beam for use as a contention free random access resource with the user equipment, the specific transmit beam being selected based on the specific transmit beam being received in the user equipment separately at more than one directional receiving filter at the receive signal strength which exceeds the threshold.

19. The apparatus according to claim 11, wherein the indication received from the base station serving the user equipment includes a list of candidate cells, each one of which is controlled by the apparatus, and separately for each one of the candidate cells an indication as to whether at least one transmit beam of the candidate cell is received in the user equipment separately at more than one directional receiving filter at the receive signal strength which exceeds the threshold.
